(19) United States
(12) Patent Application Publication
(10) Pub. No.: US 2022/0026234 A1
(43) Pub. Date: Jan. 27, 2022

(54) DRIVE CONTROL DEVICE, DRIVE CONTROL METHOD, AND COMPUTER PROGRAM PRODUCT

(71) Applicant: KABUSHIKI KAISHA TOSHIBA, Tokyo (JP)

(72) Inventors: Gaku MINAMOTO, Kawasaki (JP); Toshimitsu KANEKO, Kawasaki (JP); Masahiro SEKINE, Fuchu (JP)

(73) Assignee: KABUSHIKI KAISHA TOSHIBA, Tokyo (JP)

(21) Appl. No.: 17/185,546

(22) Filed: Feb. 25, 2021

(51) Int. Cl. G01C 21/36; G06K 9/00; G06T 7/70

(52) U.S. Cl. CPC G01C 21/3658; G06K 9/00798; G06K 9/00825; G06T 2207/30256; G01C 21/3691; G01C 21/3602; G01C 21/3697; G06T 7/70

(57) ABSTRACT

According to an embodiment, a drive control device configured to calculate lane attribute information including at least one of a lane recommendation degree of each lane included in lane information on a road to be traveled, a propriety of traveling each lane, and a target speed in each lane, based on own vehicle information and second vehicle information including position information and speed information on an own vehicle and a second vehicle present at a periphery of the own vehicle, route information, and map information; and determine at least one of a travel lane and a speed of the own vehicle within a range in which safety is guaranteed, using a machine learning model that receives the own vehicle information, the second vehicle information, the route information, the map information, and the lane attribute information, and outputs at least one of a travel lane and a speed.

### CROSS-REFERENCE TO RELATED APPLICATIONS

This application is based upon and claims the benefit of priority from Japanese Patent Application No. 2020-126572, filed on Jul. 27, 2020; the entire contents of which are incorporated herein by reference.

### FIELD

Embodiments described herein relate generally to a drive control device, a drive control method, and a computer program product.

### BACKGROUND

Methods using machine learning and rule-based methods are used as technologies to determine a travel lane and a speed in automated driving. The methods using machine learning require a considerable learning time, and in addition, do not guarantee safety. In contrast, the rule-based methods are safer, but are lower in travel efficiency.

### BRIEF DESCRIPTION OF THE DRAWINGS

FIG. 1 is a diagram illustrating an example of a mobile object according to a first embodiment;

FIG. 2 is a diagram illustrating an example of a functional configuration of the mobile object according to the first embodiment;

FIG. 3 is a diagram illustrating an example of route information according to the first embodiment;

FIG. 4 is a diagram for explaining calculation examples of a lane recommendation degree according to the first embodiment;

FIG. 5 is a diagram for explaining calculation examples of a propriety of traveling according to the first embodiment;

FIG. 6 is a diagram for explaining calculation examples of a target speed according to the first embodiment;

FIG. 7 is a flowchart illustrating an example of a drive control method according to the first embodiment;

FIG. 8 is a diagram illustrating an example of a functional configuration of the mobile object according to a second embodiment;

FIG. 9A is a diagram for explaining images generated by a generation unit according to the second embodiment;

FIG. 9B is a diagram illustrating an example of an image representing information near a point A of FIG. 9A;

FIG. 9C is a diagram illustrating an example of an image representing information near a point B of FIG. 9B;

FIG. 10A is a diagram for explaining an image generated by the generation unit according to the second embodiment;

FIG. 10B is a diagram illustrating an example of an image representing information near the point A of FIG. 10A;

FIG. 10C is a diagram illustrating an example of an image representing information near the point B of FIG. 10B;

FIG. 11A is a diagram for explaining an image generated by the generation unit according to the second embodiment;

FIG. 11B is a diagram illustrating an example of an image representing information near an own vehicle of FIG. 11A; and

FIG. 12 is a diagram illustrating an example of a hardware configuration of a drive control device according to the first and second embodiments.

### DETAILED DESCRIPTION

According to an embodiment, a drive control device includes an acquisition unit, a calculation unit, and a determination unit. The acquisition unit is configured to acquire own vehicle information including position information and speed information on an own vehicle, second vehicle information including position information and speed information on a second vehicle present at a periphery of the own vehicle, route information including road information representing a road to be traveled until a destination point is reached from a start point and information representing a lane to be traveled on the road, and map information including lane information on the road, legal speed limit information on the road, lane change propriety information on the road, and work information representing a work zone on the road. The calculation unit is configured to calculate lane attribute information including at least one of a lane recommendation degree of each lane included in the lane information, a propriety of traveling each lane, and a target speed in each lane, based on the own vehicle information, the second vehicle information, the route information, and the map information. The determination unit is configured to determine at least one of a travel lane and a speed of the own vehicle within a range in which safety is guaranteed, using a machine learning model that receives the own vehicle information, the second vehicle information, the route information, the map information, and the lane attribute information, and outputs at least one of a travel lane and a speed.

The following describes embodiments of a drive control device, a drive control method, and a computer program in detail with reference to the accompanying drawings.

### First Embodiment

A drive control device according to a first embodiment is mounted on, for example, a mobile object.

Example of Mobile Object

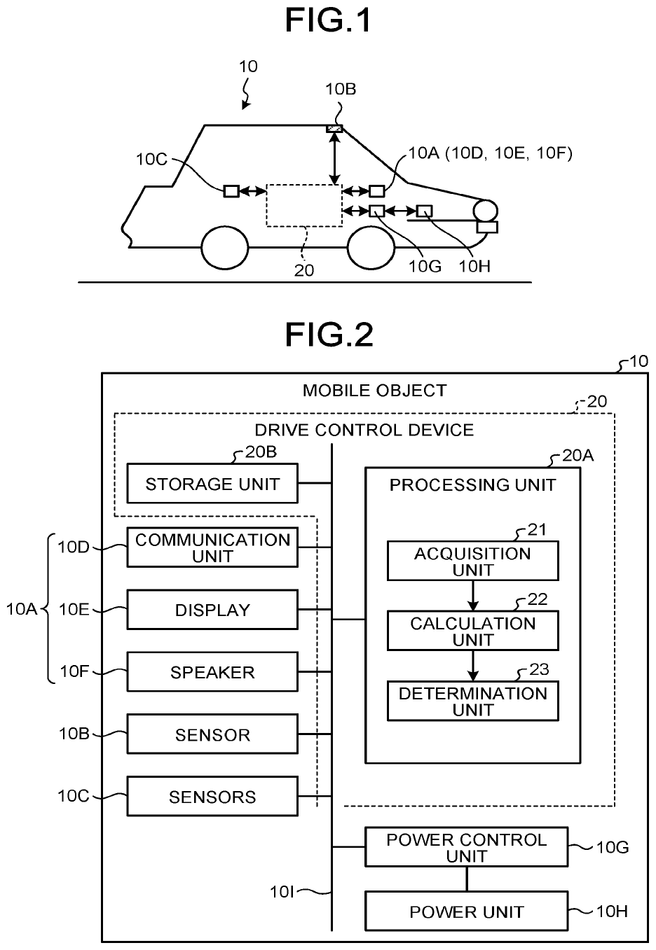

FIG. 1 is a diagram illustrating an example of a mobile object 10 according to the first embodiment.

The mobile object 10 includes a drive control device 20, an output unit 10A, a sensor 10B, sensors 10C, a power control unit 10G, and a power unit 10H.

The mobile object 10 may be any mobile object. The mobile object 10 is, for example, a vehicle, a wheeled platform, or a mobile robot. The vehicle is, for example, a two-wheeled motor vehicle, a four-wheeled motor vehicle, or a bicycle. The mobile object 10 may be, for example, a mobile object that travels via a driving operation by a person, or a mobile object that can automatically travel (autonomously travel) without the driving operation by the person.

The drive control device 20 is configured as an electronic control unit (ECU). The drive control device 20 determines at least one of a travel lane in which and a speed at which the mobile object 10 is to travel. For example, the drive control device 20 may determine only the speed, for example, in a situation where only one travel lane is available for the mobile object 10 to travel therein.

The drive control device 20 is not limited to the mode of being mounted on the mobile object 10. The drive control device 20 may be mounted on a stationary object. The stationary object is an immovable object such as an object fixed to a ground surface. The stationary object fixed to the ground surface is, for example, a guard rail, a pole, a parked vehicle, or a traffic sign. The stationary object is, for example, an object in a static state with respect to the ground surface. The drive control device 20 may be mounted on a cloud server that executes processing on a cloud system.

The power unit 10H is a drive device mounted on the mobile object 10. The power unit 10H is, for example, an engine, a motor, and wheels.

The power control unit 10G receives information representing at least one of the travel lane and the speed from a determination unit 23 of a processing unit 20A, and controls driving of the power unit 10H.

The output unit 10A outputs information. In the first embodiment, the output unit 10A outputs the information representing at least one of the travel lane and the speed determined by the drive control device 20.

The output unit 10A includes a communication function to transmit the information representing at least one of the travel lane and the speed, a display function to display the information representing at least one of the travel lane and the speed, and a sound output function to output a sound indicating the information representing at least one of the travel lane and the speed. The output unit 10A includes, for example, at least one of a communication unit 10D, a display 10E, and a speaker 10F. The first embodiment will be described by way of an example of a configuration in which the output unit 10A includes the communication unit 10D, the display 10E, and the speaker 10F.

The communication unit 10D transmits the information representing at least one of the travel lane and the speed to another device. The communication unit 10D transmits the information representing at least one of the travel lane and the speed to another device, for example, through communication lines. The display 10E displays the information representing at least one of the travel lane and the speed. The display 10E is, for example, a liquid crystal display (LCD), a projection device, or a light. The speaker 10F outputs a sound representing the information representing at least one of the travel lane and the speed.

The sensor 10B is a sensor that acquires information on the periphery of the mobile object 10. The sensor 10B is, for example, a monocular camera, a stereo camera, a fisheye camera, an infrared camera, a millimeter-wave radar, or a light detection and ranging or laser imaging detection and ranging (LIDAR) sensor. In the description herein, a camera will be used as an example of the sensor 10B. The number of the cameras (10B) may be any number. A captured image may be a color image consisting of three channels of red, green, and blue (RGB) or a monochrome image having one channel represented as a gray scale. The camera (10B) captures time-series images at the periphery of the mobile object 10. The camera (10B) captures the time-series images, for example, by imaging the periphery of the mobile object 10 in chronological order. The periphery of the mobile object 10 is, for example, a region within a predefined range from the mobile object 10. This range is, for example, a range capturable by the camera (10B).

The first embodiment will be described by way of an example of a case where the camera (10B) is installed so as to include a front direction of the mobile object 10 as an imaging direction. That is, in the first embodiment, the camera (10B) captures the images in front of the mobile object 10 in chronological order.

The sensors 10C are sensors that measure a state of the mobile object 10. The measurement information includes, for example, the speed of the mobile object 10 and a steering wheel angle of the mobile object 10. The sensors 10C are, for example, an inertial measurement unit (IMU), a speed sensor, and a steering angle sensor. The IMU measures the measurement information including triaxial accelerations and triaxial angular velocities of the mobile object 10. The speed sensor measures the speed based on rotation amounts of tires. The steering angle sensor measures the steering wheel angle of the mobile object 10.

The following describes an example of a functional configuration of the mobile object 10 according to the first embodiment.

Example of Functional Configuration

FIG. 2 is a diagram illustrating an example of the functional configuration of the mobile object 10 according to the first embodiment. The first embodiment will be described by way of an example of a case where the mobile object 10 is the vehicle.

The mobile object 10 includes the drive control device 20, the output unit 10A, the sensor 10B, the sensors 10C, the power control unit 10G, and the power unit 10H. The drive control device 20 includes the processing unit 20A and a storage unit 20B. The output unit 10A includes the communication unit 10D, the display 10E, and the speaker 10F.

The processing unit 20A, the storage unit 20B, the output unit 10A, the sensor 10B, the sensors 10C, and the power control unit 10G are connected together through a bus 101. The power unit 10H is connected to the power control unit 10C.

The output unit 10A (the communication unit 10D, the display 10E, and the speaker 10F), the sensor 10B, the sensors 10C, the power control unit 10G, and the storage unit 20B may be connected together through a network. The communication method of the network used for the connection may be a wired method or a wireless method. The network used for the connection may be implemented by combining the wired method with the wireless method.

The storage unit 20B stores therein information. The storage unit 20B is, for example, a semiconductor memory device, a hard disk, or an optical disc. The semiconductor memory device is, for example, a random-access memory (RAM) or a flash memory. The storage unit 20B may be a storage device provided outside the drive control device 20. The storage unit 20B may be a storage medium. Specifically, the storage medium may be a medium that stores or temporarily stores therein computer programs and/or various types of information downloaded through a local area network (LAN) or the Internet. The storage unit 20B may be constituted by a plurality of storage media.

The processing unit 20A includes an acquisition unit 21, a calculation unit 22, and the determination unit 23. The acquisition unit 21, the calculation unit 22, and the determination unit 23 are implemented by, for example, one processor or a plurality of processors.

The processing unit 20A may be implemented, for example, by causing a processor such as a central processing unit (CPU) to execute a computer program, that is, by software. Alternatively, the processing unit 20A may be implemented, for example, by a processor such as a dedicated integrated circuit (IC), that is, by hardware. The processing unit 20A may also be implemented, for example, using both software and hardware.

The term “processor” used in the embodiments includes, for example, a CPU, a graphical processing unit (GPU), an application-specific integrated circuit (ASIC), and a programmable logic device. The programmable logic device includes, for example, a simple programmable logic device (SPLD), a complex programmable logic device (CPLD), and a field-programmable gate array (FPGA).

The processor reads and executes a computer program stored in the storage unit 20B to implement the processing unit 20A. Instead of storing the computer program in the storage unit 20B, the computer program may be directly incorporated in the circuit of the processor. In that case, the processor reads and executes the computer program incorporated in the circuit to implement the processing unit 20A.

The following describes functions of the processing unit 20A.

The acquisition unit 21 acquires information including, for example, own vehicle information, second vehicle information, route information, and map information from outside the drive control device 20.

The own vehicle information includes at least position information and speed information on an own vehicle. For example, the position information on the own vehicle is acquired, for example, by identifying the current coordinates of the vehicle using a global navigation satellite system (GNSS), and further identifying a direction of the vehicle using the sensors. The speed information on the own vehicle is acquired from, for example, the sensors 10C mounted on the vehicle.

The second vehicle information includes the position information and the speed information on a second vehicle present at the periphery of the own vehicle. The second vehicle information is calculated, for example, based on a relative positional relation and a relative speed with respect to the own vehicle that are obtained from the sensor 10B. Alternatively, the second vehicle information is calculated, for example, based on information transmitted through vehicle-to-vehicle communication from the second vehicle present at the periphery to the own vehicle.

The map information includes, for example, coordinates of roads, positions of intersections, junctions on roads, branch points, traffic sign information, road surface marking information, road networks, and road work information.

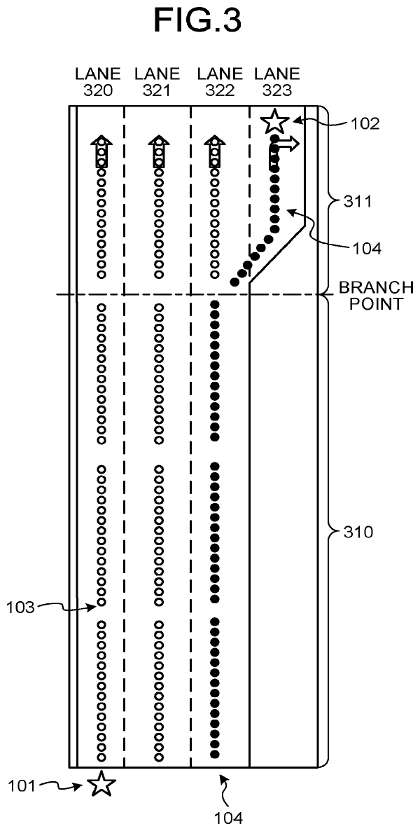

FIG. 3 is a diagram illustrating an example of the route information according to the first embodiment. The route information includes information on a planned travel route that is planned to be traveled by the vehicle. The planned travel route is acquired, for example, from an automotive navigation system mounted on the vehicle. In the example of FIG. 3, the route information includes lanes of a road to be traveled from a start point 101 in a lane 320 to a destination point 102 in a lane 323, the number of the lanes, and a lane 104 to be traveled. Data representing a lane of the road is expressed, for example, as an array of way points 103 that includes position coordinate information and information on a direction in which the vehicle is to travel in the position. The example of FIG. 3 illustrates lanes 320 to 323 as point sequences (way point sequences) of the way points 103.

The route information is indicated road segment by road segment. In the example of FIG. 3, road segments 310 and 311 are demarcated from each other at a branch point at which the lane 322 branches into the lane 322 and the lane 323. Since the destination point 102 is located in the lane 323 of the road segment 311, the lane 104 to be traveled in the road segment 311 is the lane 323. Since the road segment 310 does not have the lane 323, the lane 322 closest to the lane 323 serves as the lane 104 to be traveled. The determination unit 23 to be described later determines the travel lane from among the lanes included in the route information.

Referring back to FIG. 2, the calculation unit 22 calculates at least one of a lane recommendation degree, a propriety of traveling, and a target speed in each of the lanes through a rule-based approach based on the information acquired by the acquisition unit 21, and outputs the result as an attribute value of the lane.

The lane recommendation degree is information representing how desirable the travel of the own vehicle is in order to reach the destination point 102 on the planned travel route. For example, the lane recommendation degree is calculated as a reciprocal of a distance from the current position to a lane to be traveled. Alternatively, for example, the lane recommendation degree may be weighted corresponding to a distance from the current position of the own vehicle to the branch point.

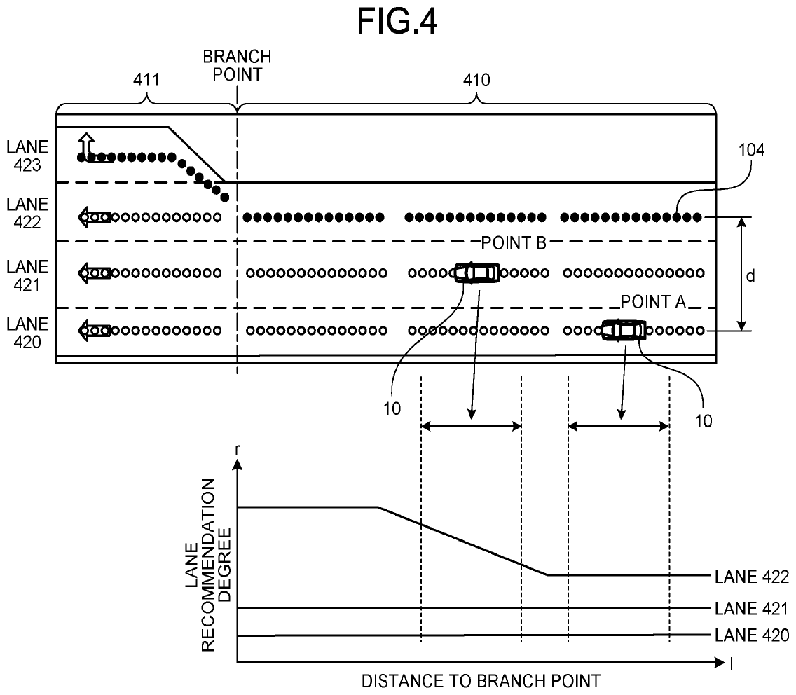

FIG. 4 is a diagram for explaining calculation examples of a lane recommendation degree r according to the first embodiment. For example, in a case where the lane 104 to be traveled in a road segment 410 is a lane 422, when the own vehicle (mobile object 10) is located at a point A in a lane 420 and the distance to the center of the lane 422 to be traveled is d, the calculation unit 22 calculates the lane recommendation degree r of the lane 420 to be a reciprocal l/d of the distance d. That is, the calculation unit 22 identifies the distance d between each of the lanes and the lane to be traveled from road information, and calculates the lane recommendation degree r of the lane to be higher as the distance d is smaller.

The own vehicle cannot reach the destination located down a lane 423 unless the own vehicle travels in the lane 423 in the road segment 411. Therefore, the own vehicle needs to travel in the lane 422 at the time of reaching the branch point. In this case, the calculation unit 22 calculates the lane recommendation degree r of the lane 422 corresponding to a distance l from the current position of the own vehicle to the branch point. The own vehicle is sufficiently distant from the branch point at the point A of FIG. 4, and, when the own vehicle is near the point A, the calculation unit 22 calculates the lane recommendation degree r corresponding to the distance d to the lane 422 regardless of the distance l to the branch point. When the own vehicle is near a point B at which the distance l to the branch point is smaller, the calculation unit 22 calculates the lane recommendation degree r of the lane 422 to be larger as the distance l to the branch point is smaller. That is, the calculation unit 22 identifies the branch point of the lane from the road information, and, if the lane to be traveled is changed to another lane at the branch point, calculates the lane recommendation degree r of the lane (lane 422 in FIG. 4) branching at the branch point to be higher as the distance l to the branch point is smaller.

When the lane recommendation degree r is calculated, the calculation may take into account a driving manner of whether an overtaking operation should be made from the right side or the left side of an overtaken mobile object. For example, when the overtaking operation is to be made, the calculation unit 22 calculates a lane recommendation degree r2 of a lane on the right side of the lane traveled by the own vehicle to be higher than a lane recommendation degree r1 of a lane on the left side of the lane traveled by the own vehicle.

The calculation unit 22 calculates lane attribute information representing the lane recommendation degree r based on the route information, and supplies the lane attribute information to the determination unit 23. Through this processing, when the determination unit 23 determines at least one of the travel lane and the speed, the determination unit 23 can determine the travel lane (speed) taking into account the lane to be traveled.

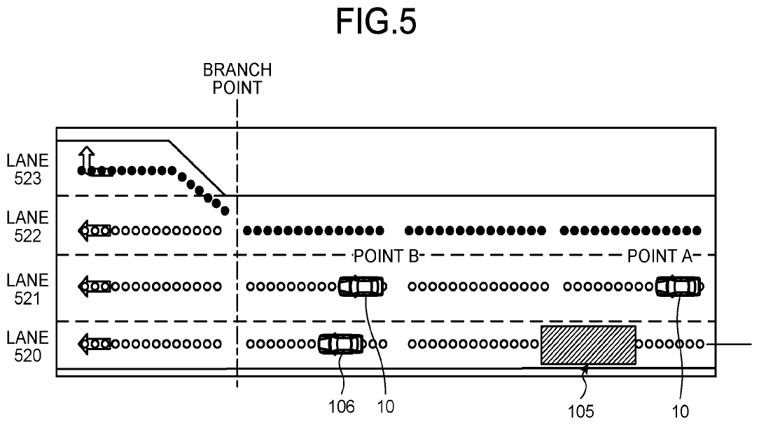

FIG. 5 is a diagram for explaining calculation examples of the propriety of traveling according to the first embodiment. The calculation unit 22 calculates the propriety of traveling each of the lanes based on the own vehicle information, the second vehicle information, and the map information. For example, at the point A of FIG. 5, the calculation unit 22 identifies information that a work zone 105 of the road is present in a lane 520 from the map information, and sets the lane 520 including the work zone 105 to be untravelable. The attribute value representing the propriety of traveling is indicated as 1 when the lane is travelable, and indicated as 0 when the lane is untravelable.

At the point B of FIG. 5, the calculation unit 22 uses the own vehicle information, the second vehicle information, and the map information to identify that a second vehicle 106 is present in the lane 520 at the periphery of the own vehicle, and determines that the lane 520 is untravelable if a relative distance and a relative speed between the own vehicle (mobile object 10) and the second vehicle 106 do not satisfy thresholds. Specifically, for example, the calculation unit 22 calculates the relative distance between the second vehicle 106 traveling in the lane at the periphery of the lane traveled by the own vehicle and the own vehicle based on the position information on the own vehicle, the position information on the second vehicle 106, and lane information. The calculation unit 22 calculates the relative speed between the own vehicle and the second vehicle 106 based on the speed information on the own vehicle and the speed information on the second vehicle. Then, if the relative distance is smaller than a first threshold and the relative speed is higher than a second threshold, the calculation unit 22 sets the propriety of traveling the lane at the periphery (lane 520 in FIG. 5) to be untravelable.

The calculation unit 22 calculates the lane attribute information representing the propriety of traveling based on the own vehicle information, the second vehicle information, and the map information, and supplies the lane attribute information to the determination unit 23. Through this processing, when the determination unit 23 determines at least one of the travel lane and the speed of the own vehicle, the determination unit 23 can determine the travel lane (speed) avoiding a collision and taking into account the safety.

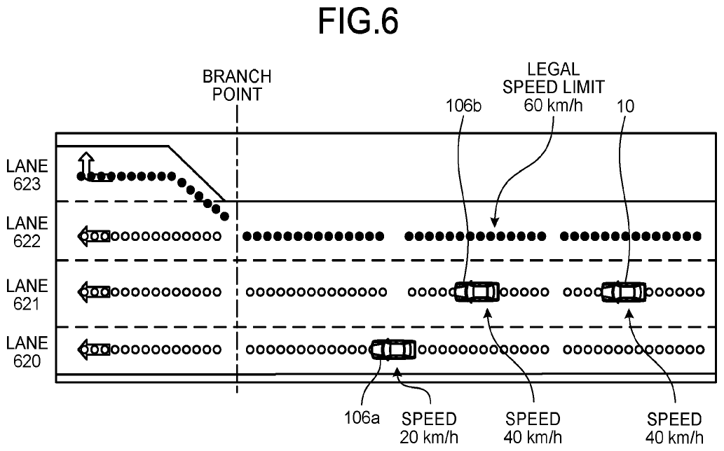

FIG. 6 is a diagram for explaining calculation examples of the target speed according to the first embodiment. The target speed is a speed that is targeted in the lane traveled by the own vehicle. The calculation unit 22 calculates the target speed in each of the lanes based on the position information on the own vehicle, the speed information on the own vehicle, the position information on the second vehicle, the speed information on the second vehicle, and legal speed limit information.

For example, in FIG. 6, the own vehicle (mobile object 10) is traveling at a speed of 40 km/h in a lane 621, and a second vehicle 106b is traveling at a speed of 40 km/h in front of the own vehicle. A second vehicle 106a is traveling at a speed of 20 km/h in a lane 620. No other vehicles are present in a lane 622. In this case, for example, the calculation unit 22 calculates the target speed in the lane 620 to be 20 km/h so as to follow the second vehicle 106a in front of the own vehicle. In the same way, the calculation unit 22 calculates the target speed in the lane 621 to be 40 km/h so as to follow the second vehicle 106b in front of the own vehicle. Since no other vehicles are present in the lane 622, the calculation unit 22 identifies a legal speed limit of this road from the map information, and calculates the target speed in the lane 622 to be the legal speed limit (for example, 60 km/h).

The calculation unit 22 calculates the lane attribute information representing the target speed based on the own vehicle information, the second vehicle information, and the map information, and supplies the target speed to the determination unit 23. Through this processing, when the determination unit 23 determines at least one of the travel lane and the speed of the own vehicle, the determination unit 23 can determine the travel lane (speed) taking into account a travel efficiency.

Referring back to FIG. 2, the determination unit 23 determines at least one of the travel lane and the speed using a machine learning model that receives the information (the own vehicle information, the second vehicle information, the route information, and the map information) acquired by the acquisition unit 21 and the lane attribute information output by the calculation unit 22, and outputs at least one of the travel lane and the speed.

The determination unit 23 trains the machine learning model, for example, using reinforcement learning. For example, a difference from the target speed calculated by the calculation unit 22 is used as a reward in the learning. The machine learning model determines at least one of the travel lane and the speed based on, for example, the own vehicle information and the second vehicle information acquired by the acquisition unit 21, and on, for example, the propriety of traveling calculated by the calculation unit 22, without selecting, for example, zones where no lanes are present, lanes where risk of collision with another vehicle is present, and lanes that are untravelable because road work is under way. As a result, efficient travel can be achieved while guaranteeing safety.

In the reinforcement learning, the difference from the target speed and the distance to the destination are used as the reward, and the machine learning model receives the lane recommendation degree and the target speed calculated by the calculation unit 22. Through this processing, at least one of the travel lane and the speed can be determined taking into account the route information. As a result, the own vehicle can reach the destination while keeping the efficient travel. Specifically, for example, when the second vehicle 106 traveling at a lower speed than that of the own vehicle is present in front of the own vehicle in the lane to be traveled, the travel lane and the speed can be determined such that the own vehicle once moves away from the lane to be traveled, and after overtaking the vehicle 106 traveling at a lower speed, returns to the lane to be traveled.

For example, the number of times of collision, the distance from the lane to be traveled, and the number of times of lane change may be used as the reward in the reinforcement learning.

Example of Drive Control Method

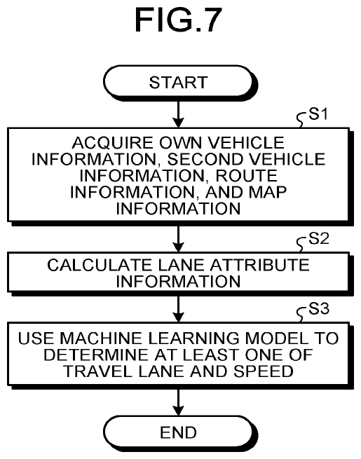

FIG. 7 is a flowchart illustrating an example of the drive control method according to the first embodiment. First, the acquisition unit 21 acquires the own vehicle information including the position information and the speed information on the own vehicle (mobile object 10), the second vehicle information including the position information and the speed information on the second vehicle 106 present at the periphery of the own vehicle, the route information including the road information representing the road to be traveled until the own vehicle reaches the destination point 102 from the start point 101 and the information representing the lanes to be traveled on the road, and the map information including the lane information on the road, the legal speed limit information on the road, lane change propriety information on the road, and the work information representing the work zone 105 on the road (Step S1).

Then, based on the own vehicle information, the second vehicle information, the route information, and the map information, the calculation unit 22 calculates the lane attribute information including at least one of the lane recommendation degree r of each of the lanes, the propriety of traveling each of the lanes, and the target speed in each of the lanes that are included in the lane information (Step S2).

Then, using the machine learning model that receives the own vehicle information, the second vehicle information, the route information, the map information, and the lane attribute information, and outputs at least one of the travel lane and the speed, the determination unit 23 determines at least one of the travel lane and the speed of the own vehicle within a range in which safety is guaranteed (Step S3).

Effect of First Embodiment

The above-described drive control device 20 according to the first embodiment can determine the travel lane and the speed while ensuring both the safety and the travel efficiency in the automated driving. Specifically, a minimum level of safety through the rule-based approach can be guaranteed by supplying the lane attribute information calculated by the calculation unit 22 to the machine learning model. The determination unit 23 can determine a driving behavior providing a good travel efficiency through a leaning-based approach by determining at least one of the travel lane and the speed of the own vehicle using the machine learning model.

### Second Embodiment

The following describes a second embodiment. In the description of the second embodiment, the same description as that of the first embodiment will not be repeated, and portions different from those of the first embodiment will be described.

In the first embodiment, the information (the own vehicle information, the second vehicle information, the route information, and the map information) output by the acquisition unit 21 and the lane attribute information output by the calculation unit 22 are supplied as they are to the determination unit 23. In the second embodiment, a case will be described where, in order to make the learning more efficient, an image is generated from the information output by the acquisition unit 21 and the calculation unit 22, and the image is supplied to the machine learning model.

Example of Functional Configuration

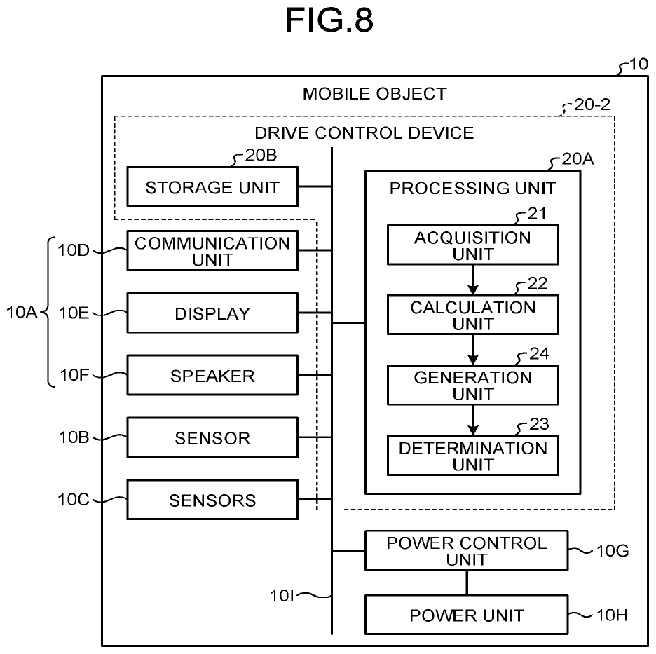

FIG. 8 is a diagram illustrating an example of a functional configuration of the mobile object 10 according to the second embodiment. The mobile object 10 includes a drive control device 20-2, the output unit 10A, the sensor 10B, the sensors 10C, the power control unit 10G, and the power unit 10H. The drive control device 20-2 includes the processing unit 20A and the storage unit 20B.

The processing unit 20A includes the acquisition unit 21, the calculation unit 22, the determination unit 23, and a generation unit 24. In the second embodiment, the generation unit 24 is further added.

The generation unit 24 generates one or more images that represent, by pixel values, at least one of the propriety of traveling, the lane recommendation degree, and the target speed at the periphery of the own vehicle (mobile object 10) based on the own vehicle information, the second vehicle information, the route information, the map information, and the lane attribute information. The generation unit 24 uses at least one piece of the lane attribute information output by the calculation unit 22 to generate at least one image. The generation unit 24 may use a plurality of attribute values to generate a plurality of images, and may supply the images to the determination unit 23.

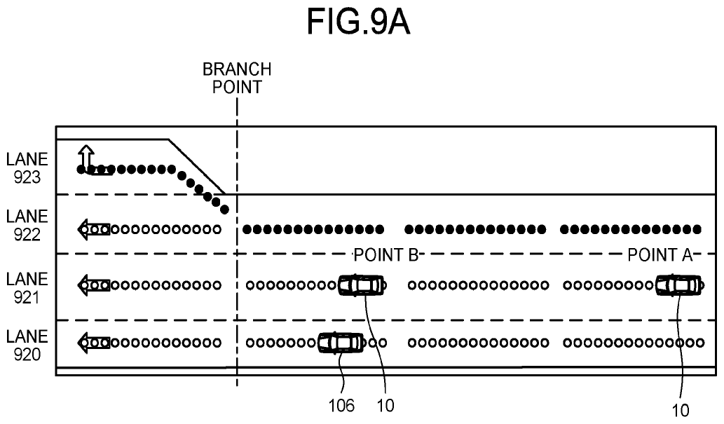

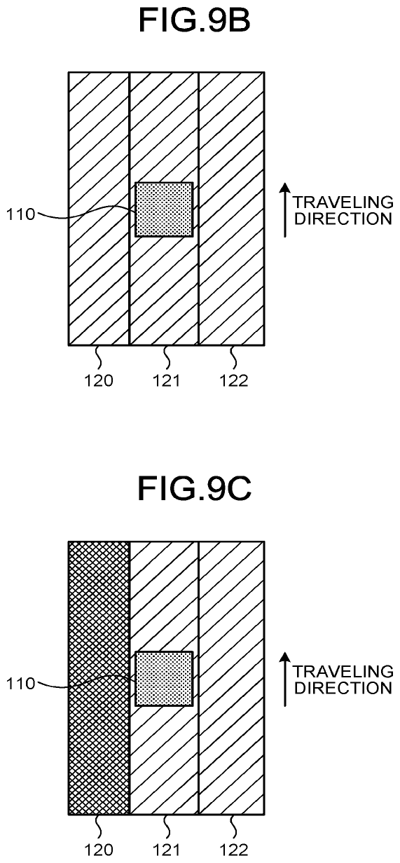

FIG. 9A is a diagram for explaining the images generated by the generation unit 24 according to the second embodiment. FIG. 9B is a diagram illustrating an example of an image representing information near the point A of FIG. 9A. FIG. 9C is a diagram illustrating an example of an image representing information near the point B of FIG. 9B. In the examples of FIGS. 9B and 9C, the upper side of the image represents a traveling direction of the own vehicle (mobile object 10). Three vertically extending split regions 120 to 122 are regions representing lanes 920, 921, and 922, respectively, from the left side. A rectangle 110 at the center of the image represents the own vehicle, representing that the own vehicle is traveling in the lane 921.

In the images of FIGS. 9B and 9C, the propriety of traveling the lanes 920 to 922 is represented by densities of colors (pixel values) filling the regions 120 to 122 of the respective lanes. For example, in the example of FIG. 9B, no obstacle is present near the own vehicle. Accordingly, the calculation unit 22 outputs the lane attribute information representing that all the lanes are travelable. Therefore, the generation unit 24 generates the image of FIG. 9B representing that all the lanes are travelable. In contrast, in the example of FIG. 9C, an obstacle (the second vehicle 106) is present in the vicinity of the own vehicle in the lane 920. Accordingly, the calculation unit 22 outputs the lane attribute information representing that the lane 920 is untravelable. Therefore, the generation unit 24 generates the image of FIG. 9C representing that the region 120 representing the lane 920 is untravelable, and the regions 121 and 122 representing the lanes 921 and 922 are travelable.

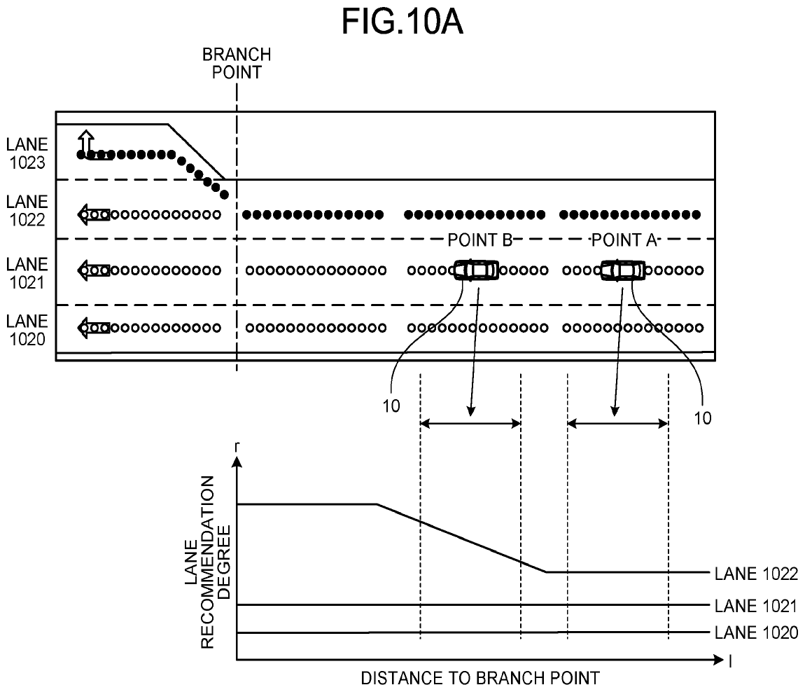

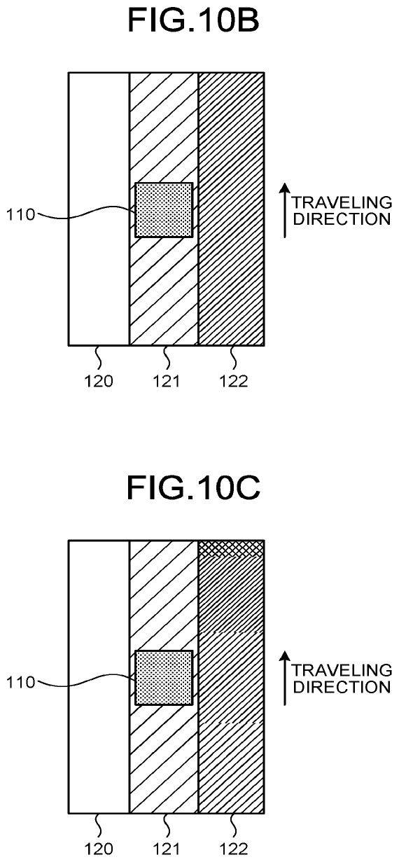

FIG. 10A is a diagram for explaining the images generated by the generation unit 24 according to the second embodiment. FIG. 10B is a diagram illustrating an example of an image representing information near the point A of FIG. 10A. FIG. 10C is a diagram illustrating an example of an image representing information near the point B of FIG. 10B.

In the images of FIGS. 10B and 10C, the lane recommendation degrees of the lanes 920 to 922 are represented by densities of colors (pixel values) filling the regions 120 to 122 of the respective lanes. For example, in the examples of FIGS. 10B and 10C, each of the regions is represented by a higher-density color as the region represents a lane having a higher lane recommendation degree. In the example of FIG. 10B, the region 122 representing the lane 1022 has the highest lane recommendation degree, and accordingly, has the highest-density color. In the example of FIG. 10C, the lane recommendation degree in the lane 922 at the periphery of the own vehicle is higher as the region 122 is closer to the branch point. Accordingly, the density of the color of the region 122 representing the lane 922 is higher toward the traveling direction of the own vehicle.

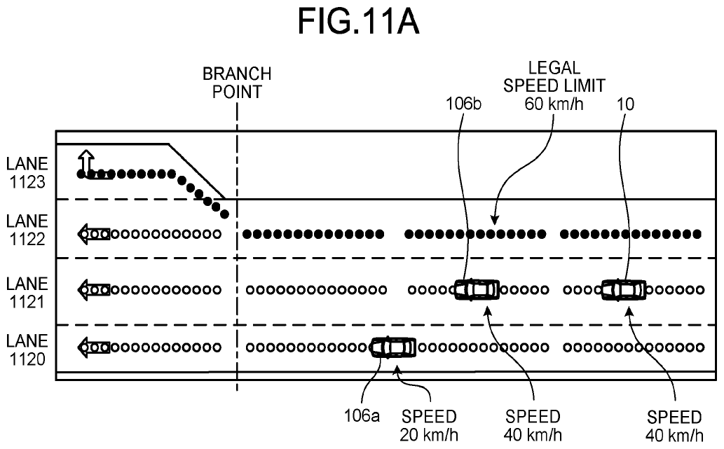

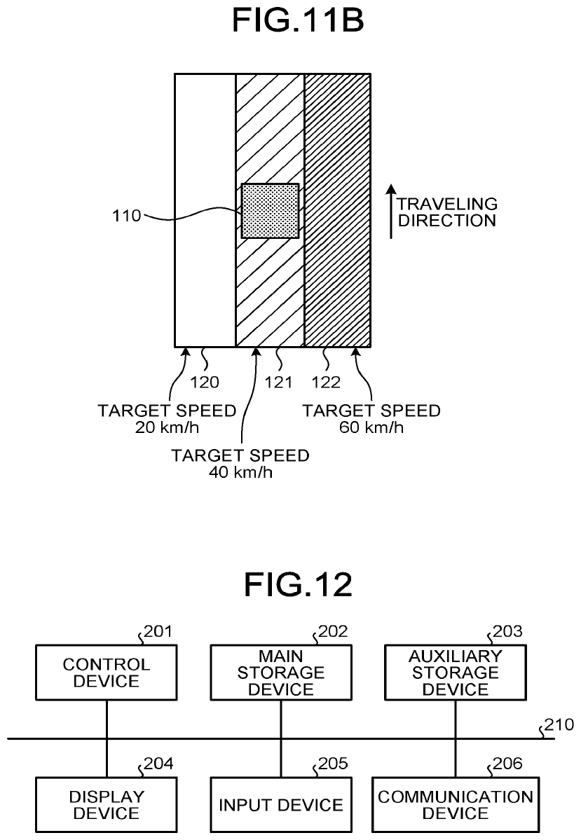

FIG. 11A is a diagram for explaining an image generated by the generation unit 24 according to the second embodiment. FIG. 11B is a diagram illustrating an example of an image representing information near the own vehicle of FIG. 11A. In the image of FIG. 11B, the target speed in the lanes 920 to 922 are represented by densities of colors (pixel values) filling the regions 120 to 122 of the respective lanes. For example, in the example of FIG. 11B, each of the regions is represented by a higher-density color as the region represents a lane having a higher target speed. In the example of FIG. 11B, the region 122 representing the lane 1122 has the highest target speed (60 km/h), and accordingly, has the highest-density color.

As described above, in the drive control device 20-2 according to the second embodiment, the generation unit 24 generates one or more images that represent, by pixel values, at least one of the propriety of traveling, the lane recommendation degree, and the target speed at the periphery of the own vehicle (mobile object 10) based on the own vehicle information, the second vehicle information, the route information, the map information, and the lane attribute information. The determination unit 23 receives the input of the own vehicle information, the second vehicle information, the route information, the map information, and the lane attribute information via the one or more images.

Thus, the drive control device 20-2 according to the second embodiment can make the learning of the machine learning model more efficient by making the input to the machine learning model in the form of the image data.

Finally, an example of a hardware configuration of the drive control device 20 (20-2) according to each of the first and second embodiments will be described.

Example of Hardware Configuration

FIG. 12 is a diagram illustrating the example of the hardware configuration of the drive control device 20 (20-2) according to each of the first and second embodiments. The drive control device 20 includes a control device 201, a main storage device 202, an auxiliary storage device 203, a display device 204, an input device 205, and a communication device 206. The control device 201, the main storage device 202, the auxiliary storage device 203, the display device 204, the input device 205, and the communication device 206 are connected together through a bus 210.

The drive control device 20 need not include the display device 204, the input device 205, and the communication device 206. For example, if the drive control device 20 is connected to a second device, the drive control device 20 may use a display function, an input function, and a communication function of the second device.

The control device 201 executes a computer program read from the auxiliary storage device 203 into the main storage device 202. The control device 201 is one or a plurality of processors such as CPUs. The main storage device 202 is a memory such as a read-only memory (ROM) and a RAM. The auxiliary storage device 203 is, for example, a memory card and/or a hard disk drive (HDD).

The display device 204 displays information. The display device 204 is, for example, a liquid crystal display. The input device 205 receives input of the information. The input device 205 is, for example, hardware keys. The display device 204 and the input device 205 may be, for example, a liquid crystal touch panel that has both the display function and the input function. The communication device 206 communicates with another device.

A computer program to be executed by the drive control device 20 is stored as a file in an installable format or an executable format on a computer-readable storage medium, such as a compact disc read-only memory (CD-ROM), a memory card, a compact disc-recordable (CD-R), or a digital versatile disc (DVD), and is provided as a computer program product.

The computer program to be executed by the drive control device 20 may be stored on a computer connected to a network such as the Internet, and provided by being downloaded through the network. The computer program to be executed by the drive control device 20 may be provided through the network such as the Internet without being downloaded.

The computer program to be executed by the drive control device 20 may be provided by being incorporated into, for example, a ROM in advance.

The computer program to be executed by the drive control device 20 has a module configuration including functions implementable by the computer program among the functions of the drive control device 20.

The functions to be implemented by the computer program are loaded into the main storage device 202 by causing the control device 201 to read the computer program from a storage medium such as the auxiliary storage device 203 and execute the computer program. That is, the functions to be implemented by the computer program are generated in the main storage device 202.

Some of the functions of the drive control device 20 may be implemented by hardware such as an IC. The IC is a processor that performs, for example, dedicated processing.

When a plurality of processors are used to implement the functions, each of the processors may implement one of the functions, or may implement two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A drive control device comprising:
a memory; and
one or more hardware processors electrically coupled to the memory and configured to function as:
an acquisition unit configured to acquire own vehicle information including position information and speed information on an own vehicle, second vehicle information including position information and speed information on a second vehicle present at a periphery of the own vehicle, route information including road information representing a road to be traveled until a destination point is reached from a start point and information representing a lane to be traveled on the road, and map information including lane information on the road, legal speed limit information on the road, lane change propriety information on the road, and work information representing a work zone on the road;
a calculation unit configured to calculate lane attribute information including at least one of a lane recommendation degree of each lane included in the lane information, a propriety of traveling each lane, and a target speed in each lane, based on the own vehicle information, the second vehicle information, the route information, and the map information; and
a determination unit configured to determine at least one of a travel lane and a speed of the own vehicle within a range in which safety is guaranteed, using a machine learning model that receives the own vehicle information, the second vehicle information, the route information, the map information, and the lane attribute information, and outputs at least one of a travel lane and a speed.

2. The device according to claim 1, wherein the calculation unit is configured to identify the work zone from the work information, and set a propriety of traveling in a lane including the work zone to be untravelable.

3. The device according to claim 1, wherein the calculation unit is configured to calculate a relative distance between the second vehicle traveling a lane at a periphery of a lane traveled by the own vehicle and the own vehicle based on the position information on the own vehicle, the position information on the second vehicle, and the lane information, calculate a relative speed between the own vehicle and the second vehicle based on the speed information on the own vehicle and the speed information on the second vehicle, and, if the relative distance is smaller than a first threshold and the relative speed is higher than a second threshold, set a propriety of traveling the lane at the periphery to be untravelable.

4. The device according to claim 1, wherein the calculation unit is configured to identify a distance d between each lane and the lane to be traveled from the road information, and calculate the lane recommendation degree of each lane to be higher as the distance d is smaller.

5. The device according to claim 1, wherein the calculation unit is configured to identify a branch point of a lane from the road information, and, if the lane to be travel is changed to another lane at the branch point, calculate a lane recommendation degree of the lane branching at the branch point to be higher as a distance l to the branch point is smaller.

6. The device according to claim 1, wherein the calculation unit is configured to calculate the target speed in each lane based on the position information on the own vehicle, the speed information on the own vehicle, the position information on the second vehicle, the speed information on the second vehicle, and the legal speed limit information.

7. The device according to claim 1, wherein the hardware processors are further configured to function as:
a generation unit configured to generate one or more images that represent, by pixel values, at least one of a propriety of traveling, a lane recommendation degree, and a target speed at the periphery of the own vehicle based on the own vehicle information, the second vehicle information, the route information, the map information, and the lane attribute information, and wherein
the determination unit is configured to receive input of the own vehicle information, the second vehicle information, the route information, the map information, and the lane attribute information via the one or more images.

8. A drive control method comprising:
acquiring, by a drive control device, own vehicle information including position information and speed information on an own vehicle, second vehicle information including position information and speed information on a second vehicle present at a periphery of the own vehicle, route information including road information representing a road to be traveled until a destination point is reached from a start point and information representing a lane to be traveled on the road, and map information including lane information on the road, legal speed limit information on the road, lane change propriety information on the road, and work information representing a work zone on the road;
calculating, by the drive control device, lane attribute information including at least one of a lane recommendation degree of each lane included in the lane information, a propriety of traveling each lane, and a target speed in each lane, based on the own vehicle information, the second vehicle information, the route information, and the map information; and
determining, by the drive control device, at least one of a travel lane and a speed of the own vehicle within a range in which safety is guaranteed, using a machine learning model that receives the own vehicle information, the second vehicle information, the route information, the map information, and the lane attribute information, and outputs at least one of a travel lane and a speed.

9. The method according to claim 8, wherein the calculating comprises identifying the work zone from the work information, and setting a propriety of traveling a lane including the work zone to be untravelable.

10. The method according to claim 8, wherein the calculating comprises calculating a relative distance between the second vehicle traveling a lane at a periphery of a lane traveled by the own vehicle and the own vehicle based on the position information on the own vehicle, the position information on the second vehicle, and the lane information, calculating a relative speed between the own vehicle and the second vehicle based on the speed information on the own vehicle and the speed information on the second vehicle, and, if the relative distance is smaller than a first threshold and the relative speed is higher than a second threshold, setting a propriety of traveling the lane at the periphery to be untravelable.

11. The method according to claim 8, wherein at the calculating, a distance d between each lane and the lane to be traveled is identified from the road information, and the lane recommendation degree of each lane is calculated to be higher as the distance d is smaller.

12. The method according to claim 8, wherein at the calculating, a branch point of a lane is identified from the road information, and, if the lane to be traveled is changed to another lane at the branch point, a lane recommendation degree of the lane branching at the branch point is calculated to be higher as a distance l to the branch point is smaller.

13. The method according to claim 8, wherein at the calculating, the target speed in each lane is calculated based on the position information on the own vehicle, the speed information on the own vehicle, the position information on the second vehicle, the speed information on the second vehicle, and the legal speed limit information.

14. The method according to claim 8, further comprising generating one or more images that represent, by pixel values, at least one of the propriety of traveling, the lane recommendation degree, and the target speed at the periphery of the own vehicle based on the own vehicle information, the second vehicle information, the route information, the map information, and the lane attribute information, wherein the determining comprises receiving input of the own vehicle information, the second vehicle information, the route information, the map information, and the lane attribute information via the one or more images.

15. A computer program product having a non-transitory computer readable medium including programmed instructions, wherein the instructions, when executed by a computer, cause the computer to function as:
an acquisition unit configured to acquire own vehicle information including position information and speed information on an own vehicle, second vehicle information including position information and speed information on a second vehicle present at a periphery of the own vehicle, route information including road information representing a road to be traveled until a destination point is reached from a start point and information representing a lane to be traveled on the road, and map information including lane information on the road, legal speed limit information on the road, lane change propriety information on the road, and work information representing a work zone on the road;
a calculation unit configured to calculate lane attribute information including at least one of a lane recommendation degree of each lane included in the lane information, a propriety of traveling each lane, and a target speed in each lane, based on the own vehicle information, the second vehicle information, the route information, and the map information; and
a determination unit configured to determine at least one of a travel lane and a speed of the own vehicle within a range in which safety is guaranteed, using a machine learning model that receives the own vehicle information, the second vehicle information, the route information, the map information, and the lane attribute information, and outputs at least one of a travel lane and a speed.

16. The product according to claim 15, wherein the calculation unit is configured to identify the work zone from the work information, and set a propriety of traveling in a lane including the work zone to be untravelable.

17. The product according to claim 15, wherein the calculation unit is configured to calculate a relative distance between the second vehicle traveling a lane at a periphery of a lane traveled by the own vehicle and the own vehicle based on the position information on the own vehicle, the position information on the second vehicle, and the lane information, calculate a relative speed between the own vehicle and the second vehicle based on the speed information on the own vehicle and the speed information on the second vehicle, and, if the relative distance is smaller than a first threshold and the relative speed is higher than a second threshold, set a propriety of traveling the lane at the periphery to be untravelable.

18. The product according to claim 15, wherein the calculation unit is configured to identify a distance d between each lane and the lane to be traveled from the road information, and calculate the lane recommendation degree of each lane to be higher as the distance d is smaller.

19. The product according to claim 15, wherein the calculation unit is configured to identify a branch point of a lane from the road information, and, if the lane to be travel is changed to another lane at the branch point, calculate a lane recommendation degree of the lane branching at the branch point to be higher as a distance l to the branch point is smaller.

20. The product according to claim 15, wherein the calculation unit is configured to calculate the target speed in each lane based on the position information on the own vehicle, the speed information on the own vehicle, the position information on the second vehicle, the speed information on the second vehicle, and the legal speed limit information.
